(19) United States
(12) Patent Application Publication
(10) Pub. No.: US 2026/0048555 A1
(43) Pub. Date: Feb. 19, 2026

(54) ULTRASONIC SCAN UNDER LOAD

(71) Applicant: Branson Ultrasonics Corporation, Brookfield, CT (US)

(72) Inventors: Scott CALDWELL, New Milford, CT (US); Eugene D. POLLASTRO, Bethel, CT (US); Michael J. DIKER, Brookfield, CT (US)

(21) Appl. No.: 18/805,908

(22) Filed: Aug. 15, 2024

(51) Int. Cl. B29C 65/00; B23K 20/10; B23K 20/22; B29C 65/08

(52) U.S. Cl. CPC B29C 66/95; B23K 20/10; B23K 20/22; B29C 65/08; B29C 66/872

(57) ABSTRACT

A method of operating an ultrasonic system under load at startup, includes taking a scan of impedance and phase of an ultrasonic stack under operating load. Determining from the scan what the resonance is under load and what the phase is at that resonance and while contacting a workpiece under load at startup, operating the ultrasonic stack at the determined resonance and phase.

### FIELD

The present disclosure relates to an ultrasonic scan under load.

### BACKGROUND

This section provides background information related to the present disclosure which is not necessarily prior art.

An ultrasonic power supply that starts with its ultrasonic stack under load has a different starting frequency than when the ultrasonic stack is in air. Often the operating frequency in air of the ultrasonic stack is known because it is designed to have a particular resonance in air. Ultrasonic power supplies have historically been designed to have a default startup frequency for the stack in air. If the power supply tries to start with the stack under load, the frequency shift often leads to an overload of the power supply. Historically many ultrasonic power supplies have had the ability to manually adjust the startup frequency, however this is an imprecise and not automatic method.

### SUMMARY

This section provides a general summary of the disclosure, and is not a comprehensive disclosure of its full scope or all of its features.

A method of operating an ultrasonic system under load at startup, includes taking a scan of impedance and phase of an ultrasonic stack under operating load. Determining from the scan what the resonance is under load and what the phase is at that resonance and while contacting a workpiece under load at startup, operating the ultrasonic stack at the determined resonance and phase.

A method of operating an ultrasonic system under load at startup, comprising:
taking a scan of impedance and phase of an ultrasonic stack under various operating loads;
determining from the scan what the resonance is under a determined load and what the phase is at that resonance; and
while contacting a workpiece under the determined load at startup, operating the ultrasonic stack at the determined resonance and phase.

According to a further aspect, a target phase of a control loop for an ultrasonic device is changed when a load of the ultrasonic system changes.

According to a further aspect, the determined load at startup is determined by a load sensor that senses a load applied by the ultrasonic stack against the workpiece.

According to a further aspect, as the load detected by the load sensor changes during a welding operation, the resonance and phase of the ultrasonic stack is changed according to the load detected by the load sensor.

According to a further aspect, an actuator supports the ultrasonic stack and the actuator is controlled by a controller to apply a load to the ultrasonic stack against the workpiece.

According to a further aspect, the determined operating load at startup is predetermined.

According to a further aspect, the ultrasonic stack includes a converter and a horn.

According to another aspect, an ultrasonic system includes an ultrasonic power supply. An ultrasonic stack is connected to the ultrasonic power supply. An actuator is configured to movably support the ultrasonic stack and configured to press the ultrasonic stack against a work piece at a load. A controller operates the actuator to apply a load on the ultrasonic stack against a workpiece at startup and for operating the ultrasonic power supply at startup according to a stored resonance and phase for the load applied to the workpiece.

According to a further aspect, the controller has a memory that stores scanned resonance and phase data for the ultrasonic system at different operating loads and at start-up of the ultrasonic stack the controller determines a resonance and phase from the memory for operation of the ultrasonic power supply according to the corresponding load applied to the workpiece.

According to a further aspect, a load sensor senses a load applied to the workpiece by the ultrasonic stack.

According to a further aspect, the controller receives a load signal from the load sensor and activates the ultrasonic stack at a resonance and phase at start-up that corresponds to the load signal. The resonance and phase can be stored or interpolated values that correspond to the load signal.

According to a further aspect, the load applied to the workpiece is predetermined by the controller.

According to a further aspect, the ultrasonic stack includes a converter and a horn.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic view of an exemplary ultrasonic welding device according to the principles of the present disclosure;

FIG. 2 is a graph of impedance and phase verses frequency with the ultrasonic stack under no contact;

FIGS. 3A and 3B are graphs of impedance and phase verses frequency with the ultrasonic stack under different levels of contact loading;

FIG. 4 is a graph of impedance and phase verses frequency with the ultrasonic stack under actuation load; and

FIG. 5 shows a graph impedance and phase under different actuation loads.

Corresponding reference numerals indicate corresponding parts throughout the several views of the drawings.

### DETAILED DESCRIPTION

Example embodiments will now be described more fully with reference to the accompanying drawings.

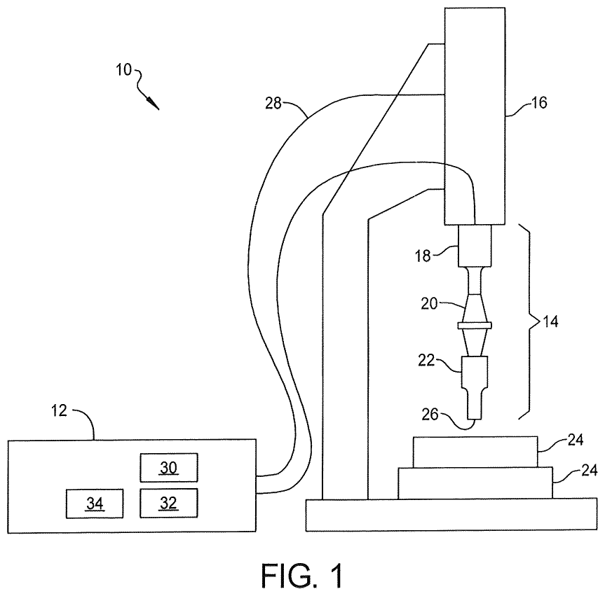

An ultrasonic system 10 usually consists of an ultrasonic power supply 12, an ultrasonic stack 14, and an actuator 16, as seen in FIG. 1. The ultrasonic stack 14 usually has an ultrasonic converter 18 that converts electrical energy from the power supply 12 to ultrasonic motion, a booster 20 that provides gain to the ultrasonic motion, and a horn 22 which does the actual work to the work piece 24. The actuator 16 moves the ultrasonic stack 14 relative to the work piece 24 so that the tip 26 of the horn 22 contacts the work piece 24.

The stack 14 may contain just a converter 18 and a horn 22, or a converter 18, booster 20 and horn 22. The stack 14 can be a linear stack, a rotary stack, a composite stack, a cross horn stack, or any combination. In other words, the stack can be anything powered by a converter. The ultrasonic system can be for any sort of ultrasonic process such as, but not limited to, welding, staking, swaging, sonification, cleaning, cutting, etc.

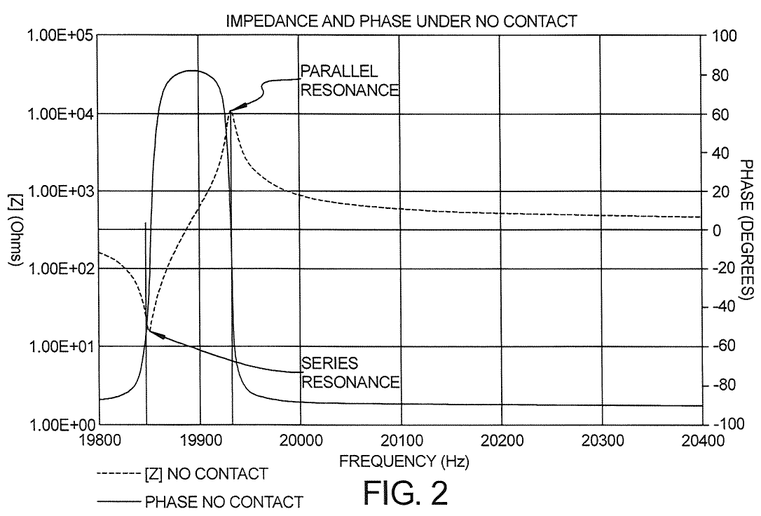

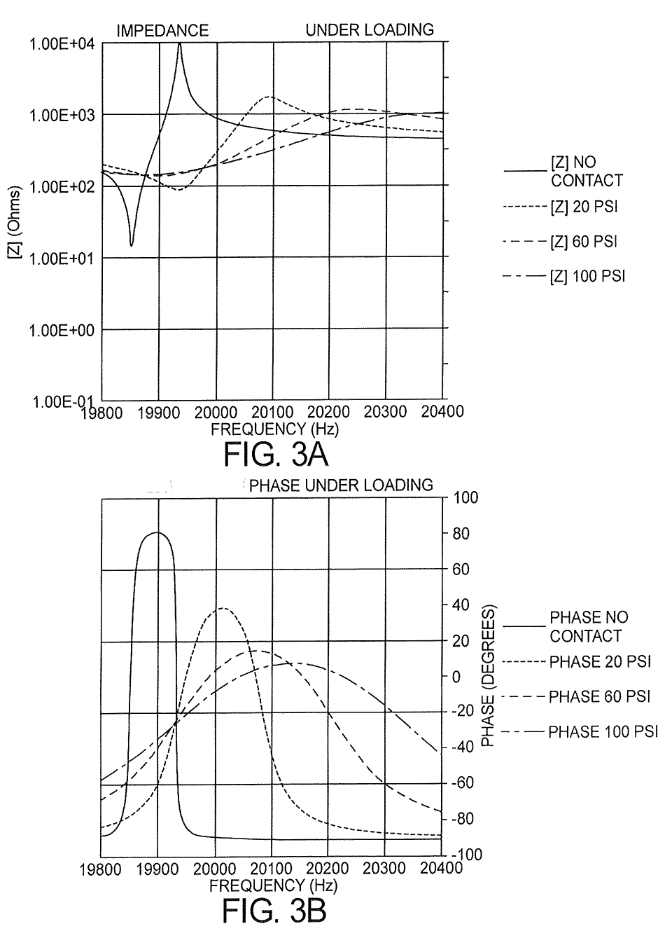

An ultrasonic stack 14 works best when it is operating at either series resonance when the impedance is at a minimum, or at parallel resonance when the impedance is at a maximum. When the ultrasonic stack 14 has no load, such as in air, resonance occurs when the phase between the current waveform and voltage waveform is approximately zero as seen in FIG. 2. When the ultrasonic stack 14 makes contact with a semi-rigid load/workpiece, however, the frequency of resonance shifts, also seen in FIG. 3A. The more the load, the more the frequency rises for parallel resonance and series resonance, but the overall impedance curve tends to squash out. Also, as seen in FIG. 3B, the phase at either resonance is no longer zero.

An ultrasonic power supply 12 that starts with its ultrasonic stack 14 under load has a different starting frequency than when the ultrasonic stack 14 is in air. Often the operating frequency in air of the ultrasonic stack 14 is known because it is designed to have a particular resonance in air. Ultrasonic power supplies have historically been designed to have a default startup frequency for the stack 14 in air. If the power supply 12 tries to start with the stack 14 under load, the frequency shift often leads to an overload of the power supply 12. Historically many ultrasonic power supplies have had the ability to manually adjust the startup frequency, however this is an imprecise and not automatic method.

In addition, the ideal operating point of the ultrasonic power supply 12 is at the stack's series or parallel resonance. In air, this corresponds to a phase between the current and voltage of approximately zero. When the stack 14 is under load, however, the phase corresponding to the series or parallel resonance drops below zero as seen in FIG. 3B. Historically ultrasonic power supplies 12 are operated at zero phase or some set value of negative phase. This is not ideal and can lead to overload.

The present disclosure solves these two problems by taking a scan of impedance and phase while the stack 14 is under the full operating load, increased or reduced power, reading where the resonance is (either series or parallel) and what the phase is at that resonance, and using that frequency to start up the ultrasonics at full power and that phase to run the ultrasonics under load. By way of example, with reference to FIGS. 3A and 3B, by entering a contact load pressure of the ultrasonic device at startup, the controller 12 can select an impedance and a phase in order to operate the ultrasonic device at startup.

Also, in dynamic variable stack loading conditions such as in a continuous textile line, the variation in loading could cause overloads of the ultrasonic power supply 12 during operation. The present disclosure solves this third problem by taking a family of scans of impedance and phase under differing loadings of the stack 14 at full, increased or reduced power, then while running the stack 14 at full power and reading the force signal 28 from the actuator 16, using the proper phase of resonance under load and varying the phase to the changing load.

The present disclosure measures the phase and impedance under various loads by having the power supply 12 conduct a scan of the phase and impedance under various loads. The scan runs the power supply 12 in a frequency sweep and measures the phase and impedance while the actuator 16 is applying a load to the workpiece 24 being worked on. The scans can be saved to a memory 32 of the power supply 12. The series and parallel resonances are calculated by a controller 30 and/or processor 34 of the power supply 12, and their associated phases are calculated.

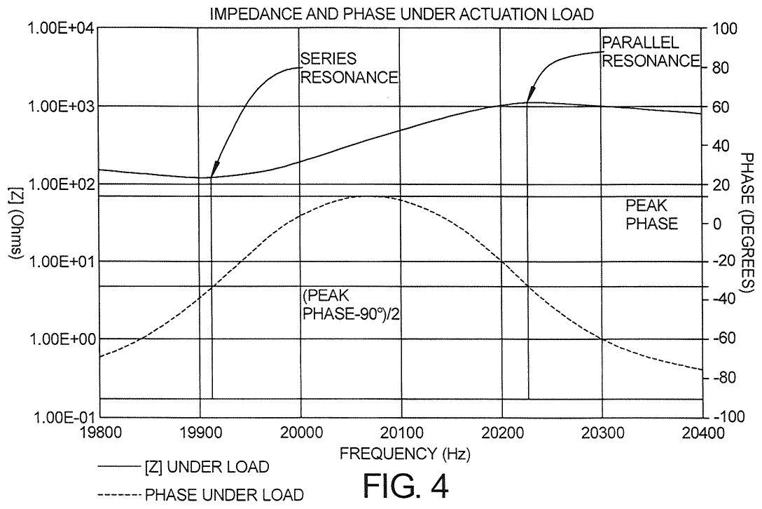

There are two ways to calculate the series and parallel resonances. With reference to FIG. 4, the first way to find the series resonance is to take the frequency where the impedance is a minimum. The first way to find the parallel resonance is to take the frequency where the impedance is a maximum. The first way to find the associated phases is to read the phases at the found impedance maxima and minima. The second way to find the two resonances is to measure the peak phase of the frequency sweep. Both resonances are approximately at a phase equal to that of half between the peak phase and −90 degrees phase. The series resonance is at the lower frequency of the phase at that value, and the parallel resonance is at the higher frequency of the phase at that value. The second method has the advantages that only the phase has to be measured during the sweep and it is more accurate since the impedance curves tend to be squashed down under loading that can make it difficult to find the peaks and troughs accurately.

At startup of the power supply 12 under actuator loading, the power supply 12 uses the resonance frequency determined from of interpolated from the loaded scans. This prevents overloads caused by starting the power supply 12 out of resonance, which would happen otherwise if the power supply 12 used the resonance at startup of the stack 14 in air. An overload condition is when the voltage and/or current going to the converter is larger than what is safe for the power supply components. Typically, in a power supply 12, a safety circuit of the power supply shuts down the power supply 12 when this condition happens to protect the components.

During operation of the power supply 12, the resonance is maintained by controlling the phase between the current and voltage of the power supply 12. The target phase used for the power supply 12 when the stack is under load is the one that is determined from or interpolated from the loaded scans. This prevents overloads. The prior art used zero phase or an arbitrary fixed negative phase which in both cases, is not an accurate representation of the phase at the loaded resonance, and therefor was more likely to cause overloads.

For applications that require variable loading during operation, such as in a textile line, scans are performed at various loading levels before operation. The family of impedance and phase curves are used to interpolate the resonance and phase at any given loading. An actuator force signal 28 communicates with the controller 30 power supply 12 during operation and provides the variable loading condition information. The appropriate phase from the interpolation is used for the given loading at any given time, changing as loading conditions change. This prevents overloads caused by varying loading conditions.

The power supply 12 can run at either parallel or series resonance. If the power supply 12 is run at series resonance, only the series resonance need be calculated by the scan under load. If the power supply 12 is run at parallel resonance, only the parallel resonance need be calculated.

The present disclosure can be used just for startup frequency under load, in which case the phase under load does not need to be known.

Impedance (Z) represents the opposition that an ultrasonic welding system offers to the flow of alternating current (AC) due to the combined effects of resistance, capacitance, and inductance. During the bonding cycle, as the two surfaces come together and the bond size grows, the impedance changes. It increases as the bond forms. In constant current mode, the ultrasonic generator output maintains a constant current. As the impedance changes, the current remains constant, resulting in an increase in voltage (V) to keep the displacement of the tool tip constant.

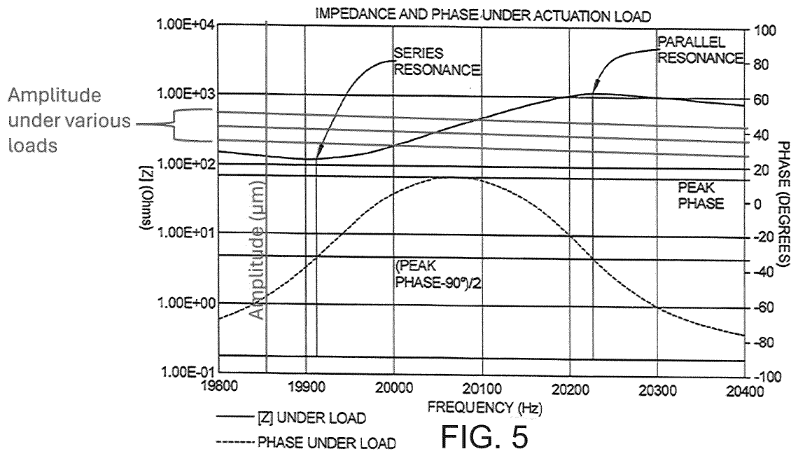

With reference to FIG. 5, a graph of impedance and phase verses frequency is shown with different amplitudes being shown under various loads. According to the principles of the present disclosure, the amplitude can be controlled for operation at start-up at various loads. An actuator force signal 28 communicates with the controller 30 power supply 12 during operation and provides the variable loading condition information. The appropriate amplitude from the interpolation is used for the given loading at any given time, changing as loading conditions change. This prevents overloads caused by varying loading conditions.

The present disclosure can be used just for operation under a constant load, in which case the starting frequency under load does not need to be known and only one phase under load needs to be known. The present disclosure can be used just for operation under variable loading, in which case the starting frequency under load does not need to be known, but the family of phase verses load needs to be known. The present disclosure can also be used with any combination of the above.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of operating an ultrasonic system under load at startup, comprising:
taking scans of impedance and phase of an ultrasonic stack under various operating loads;
determining from the scan what the resonance is under a determined load and what the phase is at that resonance; and
while contacting a workpiece under the determined load at startup, operating the ultrasonic stack at the determined resonance and phase.

2. The method of operating an ultrasonic system under load at startup according to claim 1, further comprising changing a target phase of a control loop for an ultrasonic device when a load of the ultrasonic system changes.

3. The method of operating an ultrasonic system under load at startup according to claim 1, wherein the determined load at startup is determined by a load sensor that senses a load applied by the ultrasonic stack against the workpiece and the impedance and phase are interpolated from the scans.

4. The method of operating an ultrasonic system under load at startup according to claim 3, wherein as the load detected by the load sensor changes during a welding operation, the resonance and phase of the ultrasonic stack is changed according to the load detected by the load sensor.

5. The method of operating an ultrasonic system under load at startup according to claim 1, wherein an actuator supports the ultrasonic stack and the actuator is controlled by a controller to apply a load to the ultrasonic stack against the workpiece.

6. The method of operating an ultrasonic system under load at startup according to claim 1, wherein the determined operating load at startup is predetermined.

7. The method of operating an ultrasonic system under load at startup according to claim 1, wherein the ultrasonic stack includes a converter and a horn.

8. A method of operating an ultrasonic system under load at startup, comprising:
taking scans of an amplitude of an ultrasonic stack under various operating loads;
determining an operating load of the ultrasonic system against a workpiece;
determining from the scan what the amplitude is under the determined operating load; and
while contacting a workpiece under the operating load at startup, operating the ultrasonic stack at the determined amplitude.

9. The method of operating an ultrasonic system under load according to claim 8, further comprising changing a target phase of a control loop for an ultrasonic device when a load of the ultrasonic system changes.

10. The method of operating an ultrasonic system under load according to claim 8, wherein the determined load at startup is determined by a load sensor that senses a load applied by the ultrasonic stack against the workpiece and the amplitude is interpolated from the scans.

11. The method of operating an ultrasonic system under load according to claim 10, wherein as the load detected by the load sensor changes during a welding operation, the resonance and phase of the ultrasonic stack is changed according to the load detected by the load sensor.

12. The method of operating an ultrasonic system under load according to claim 8, wherein an actuator supports the ultrasonic stack and the actuator is controlled by a controller to apply a load to the ultrasonic stack against the workpiece.

13. The method of operating an ultrasonic system under load according to claim 8, wherein the determined operating load at startup is predetermined.

14. The method of operating an ultrasonic stack system under load according to claim 8, wherein the ultrasonic stack includes a converter and a horn.

15. An ultrasonic system, comprising:
an ultrasonic power supply;
an ultrasonic stack connected to the ultrasonic power supply;
an actuator configured to movably support the ultrasonic stack and configured to press the ultrasonic stack against a work piece at a load; and
a controller for operating the actuator to apply a load on the ultrasonic stack against a workpiece at startup and for operating the ultrasonic power supply at startup according to a stored resonance and phase for the load applied to the workpiece.

16. The ultrasonic system according to claim 15, wherein the controller has a memory that stores scanned resonance and phase data for the ultrasonic system at different operating loads and at start-up of the ultrasonic stack the controller determines a resonance and phase from the memory for operation of the ultrasonic power supply according to the corresponding load applied to the workpiece.

17. The ultrasonic system according to claim 15, further comprising a load sensor for sensing a load applied to the workpiece by the ultrasonic stack.

18. The ultrasonic system according to claim 17, wherein the controller receives a load signal from the load sensor and activates the ultrasonic stack at a stored resonance and phase at start-up that corresponds to the load signal.

19. The ultrasonic system according to claim 15, wherein the load applied to the workpiece is predetermined.

20. The ultrasonic system according to claim 15, wherein the ultrasonic stack includes a converter and a horn.
